(19) United States
(12) Patent Application Publication
(10) Pub. No.: US 2026/0135772 A1
(43) Pub. Date: May 14, 2026

(54) COMMUNICATION NETWORK SERVICE DEPLOYMENT VIA GENERATIVE MACHINE LEARNING MODEL

(71) Applicants: AT&T Intellectual Property I, L.P., Atlanta, GA (US); AT&T Mobility II LLC, Atlanta, GA (US)

(72) Inventors: Prashant Raghuvanshi, Parker, CO (US); Richard T. Kwapniewski, Middletown, NJ (US)

(21) Appl. No.: 18/948,457

(22) Filed: Nov. 14, 2024

(51) Int. Cl. H04L 41/16; H04L 41/0816

(52) U.S. Cl. CPC H04L 41/16; H04L 41/0816

(57) ABSTRACT

A processing system including at least one processor may obtain a client intent for a network service in a communication network. The processing system may next apply an input vector comprising the client intent to a generative machine learning model to obtain an output of the generative machine learning model comprising a network configuration. The processing system may then reconfigure the communication network according to the network configuration.

The present disclosure relates generally to communication network operations, and more specifically to methods, computer-readable media, and apparatuses for reconfiguring a communication network according to a network configuration obtained as an output of a generative machine learning model in accordance with a client intent for a network service.

### BACKGROUND

A large communication network may collect and process a substantial volume of data generated by devices/systems. Such data may be primarily maintained in database tables, e.g., in a structured query language (SQL) format or a “not only SQL” (NoSQL) format. In addition, tables, or rows and columns thereof may be associated or linked to one another to maintain additional knowledge in a graph database, and so forth.

### SUMMARY

The present disclosure describes methods, computer-readable media, and apparatuses for reconfiguring a communication network according to a network configuration obtained as an output of a generative machine learning model in accordance with a client intent for a network service. For instance, in one example, a processing system including at least one processor may obtain a client intent for a network service in a communication network. The processing system may next apply an input vector comprising the client intent to a generative machine learning model to obtain an output of the generative machine learning model comprising a network configuration. The processing system may then reconfigure the communication network according to the network configuration.

### BRIEF DESCRIPTION OF THE DRAWINGS

The present disclosure can be readily understood by considering the following detailed description in conjunction with the accompanying drawings, in which:

FIG. 1 illustrates an example of a system related to the present disclosure;

FIG. 2 illustrates an example process for providing an automatic generative machine learning model-based network service configuration, in accordance with the present disclosure;

FIG. 3 illustrates a flowchart of an example method for reconfiguring a communication network according to a network configuration obtained as an output of a generative machine learning model in accordance with a client intent for a network service; and

FIG. 4 illustrates a high-level block diagram of a computing device specially programmed to perform the functions described herein.

To facilitate understanding, identical reference numerals have been used, where possible, to designate identical elements that are common to the figures.

### DETAILED DESCRIPTION

The present disclosure broadly discloses methods, non-transitory (i.e., tangible or physical) computer-readable media, and apparatuses for reconfiguring a communication network according to a network configuration obtained as an output of a generative machine learning model in accordance with a client intent for a network service. In particular, examples of the present disclosure may ingest natural language requests/prompts for a network service deployment which may be mapped to client intents from which network configurations may be generated using generative artificial intelligence (AI) and/or machine learning (ML) (collectively referred to as generative AI, or genAI). To illustrate, examples of the present disclosure may start with a client request for a network service, which may be mapped to a client intent. For instance, the client intent may be associated with a template that defines one or more objective criteria, e.g., one or more network performance indicator thresholds for one or more network performance indicator types. From the client intent, the present disclosure may mine a networking architecture knowledge base, such as 3^{rd} Generation Partnership Project (3GPP) technical standards (TS) and other documentation, to derive a template network configuration via a generative AI process.

To further illustrate, examples of the present disclosure may begin with a use case, or client intent, such as a “low latency” service. For instance, low latency may be considered to be less than or equal to 3 ms end-to-end, e.g., between an endpoint device/client and a network-based server. In one example, the client intent may be derived from a natural language request/prompt, e.g., for a network service. In particular, the natural language request/prompt may be mapped to the client intent, e.g., a particular client intent from among a plurality of available client intent types/use cases via an intent mapping function. The client intent may be provided to a generative AI module that may gather data from relevant network communications and network architecture standards documentation, such as 3GPP technical standards. Examples of the present disclosure may further apply the client intent along with the network architecture standards documentation (e.g., as supplemental prompt content) to a generative machine learning model (MLM) that is trained to generate a recommended network configuration or “network blueprint” (e.g., that is expected to support the client intent) as an output. For instance, network blueprint may include one or more network functions (NFs) to support the client intent, e.g., a requested network service, as well as interfaces between NFs, micro services, configurations/settings, etc. on the NFs, or the like.

Thus, the present disclosure may obtain such a recommended network configuration as the output of the generative MLM, and may implement the network configuration to support the requested network service. For instance, in one example, the present disclosure may instruct a self-optimizing network (SON) orchestrator and/or a service management orchestrator (SMO) or the like. For instance, a generative MLM-produced network configuration for a low latency use case/client intent may include four network functions, e.g., a base station (gNB or gNodeB), an access management function, (AMF), a session management function (SMF), and a user plane function (UPF). The SMO may further generate deployment artifacts such as interfaces and day 1 and day 2 configurations, etc., and may start the network deployment/provisioning, e.g., reconfiguring the network in accordance with the generative MLM produced network configuration. Once the network is configured/reconfigured in accordance with the network configuration, in one example, one or more automated test tools may run one or more tests, e.g., to verify that low latency (e.g., quantified in this example as less than or equal to 3 ms) is observed. For instance, an automated test tool may comprise a new type of network operator-defined NF and/or a 3rd party NF that runs tests such as a ping test, etc., e.g., to see that latency is less than 3 ms in accordance with the client intent. For instance, the testing may establish that latency is less than 1 ms in a cellular core and less than 1 ms latency in a radio access network (RAN) such that the total end-to-end latency may generally be less than 3 ms total. Other network testings may be applied with respect to other client intents which may have other performance indicator thresholds defining/associated with such client intents.

In the event that the client intent is not met, in one example the processing system may collect such network performance indicator data and engage in additional inferences to generate a different network configuration, to deploy the different network configuration, to test the new network configuration to verify compliance with the client intent, etc. For example, the “additional inferences” may include applying the client intent and standards documentation to the generative MLM along with further supplemental prompt content indicating that the prior recommended network configuration did not meet the client intent. In one example, this process may continue in an on-demand, automated fashion until the client intent of low latency (e.g., less than or equal to 3 ms for an end-to-end communication) is met. As such, the present disclosure may test to determine if the client intent is met, and if not, then the process may be repeated until the client intent is met or exceeded.

Examples of several types of client intents may include low latency, such as discussed above (e.g., defined by end-to-end latency less than or equal to 3 ms). As another example, a second type of client intent may be an “augmented reality (AR)/virtual reality (VR)” client intent. For instance, this client intent may call for low latency but may be intended to support 8K video. Thus, for example, an AR/VR client intent may be defined by several performance indicators, such as end-to-end latency less than or equal to 5 ms, downlink throughput greater than 50 MB/s, and uplink throughput greater than 15 MB/s. Thus, in general, each client intent can be defined as one or more performance indicator thresholds for one or more performance indicator types, e.g., key performance indicator (KPI) type(s).

As another example, a “smart city” client intent may be intended to support low power, low cost devices that are spread out and communicate with each other sporadically. In this case, the client intent may itself define that traffic for a requesting client is assigned to an ultra-reliable low latency communication (URLLC) slice. In such case, the generative MLM may produce a network configuration for the URLLC slice to have a more stringent power saving model, e.g., as compared to other slices available/deployed in the same relevant geographic area or network zone. In addition, the network configuration may include configurations/settings of one or more NFs that enable UEs to sleep more often and communicate only when necessary (e.g., less frequent paging, etc.). For example, a recommended network configuration/blueprint may call for a gNB to be configured with discontinuous reception (DRX) settings, and an AMF to control the DRX settings. It should be noted that in another example, the client intent may define additional aspects of the network configuration, such as the fact that a URLLC slice is to be used. In other words, more is defined in the client intent itself, and less is delegated to the generative MLM to “fill in” as further details of a network configuration.

Another example client intent type may be a “private network” client intent type. For instance, the performance indicator thresholds for this type of client intent may include one or more relating to increased network/communication security. In this case, the generative MLM may produce a recommended network configuration which may include dedicated devices (e.g., not shared with other traffic), may include backup/redundant elements, and so forth. Similar to the above, in another example, aspects of the network configuration may be defined or indicated in the client intent. For instance, the client intent itself may define that dedicated (non-shared) devices and/or NFs be used, where the generative MLM may produce a network configuration with additional details, such as the processor and memory capabilities, the interfaces between devices and/or NFs, reserved link bandwidth, etc. As still another example, a client intent of “network edge” may generally call for shared elements, but providing a user plane path as close to a user endpoint device as possible. Thus, (1) low latency, (2) high throughput, and (3) local application server capability may be three factors to define the client intent (the first two being network performance indicators, and the last being a non-negotiable feature). Accordingly, in such an example the generative MLM may produce a recommended network configuration that includes the local application server and gNB configuration(s) that enable end-to-end latency (e.g., between the user endpoint device and a local application server) of less than or equal to 3 ms and an uplink throughput of greater than 30 MB/s.

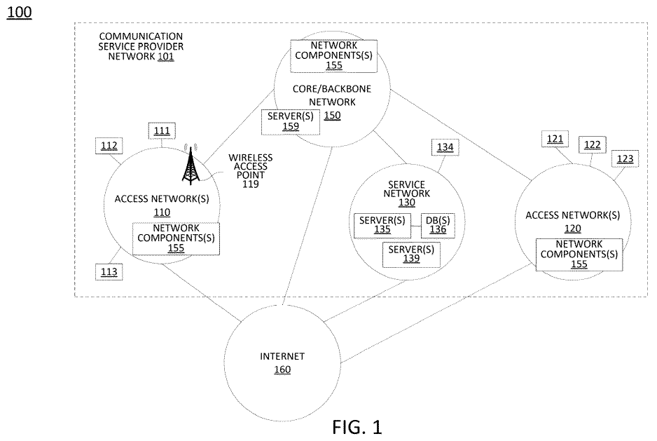

Various additional client intents may be provided and supported in accordance with the present disclosure. In one example, new client intents may be defined and templates for the client intents added to a set of available client intents. In one example, client intents may be split into more specific client intents via machine learning based upon system usage. For instance, a low latency client intent may be split into “low latency for less than 100 devices” and “low latency for more than 100 devices” client intents. For example, a user may specify a client intent of “low latency” and a network configuration may be deployed in accordance with an output of the generative MLM. However, the user may determine that the network service is not working as the user would hope (e.g., not meeting the client's expectation), which may be due the user failing to specify that the network service would be for heavy use (e.g., greater than 100 endpoint devices). In this case, the user may provide an additional request that asks for a low latency network service for greater than 100 users. As such, the present disclosure may learn from a new network configuration that may be generated from such a new request/prompt and may define a new client intent type in accordance therewith. These and other aspects of the present disclosure are discussed in greater detail below in connection with the examples of FIGS. 1-4.

To aid in understanding the present disclosure, FIG. 1 illustrates an example system 100 comprising a plurality of different networks in which examples of the present disclosure may operate. Communication service provider network 101 may comprise a core network and/or backbone network 150 with components for telephone services, Internet services, and/or video services (e.g., triple-play services, etc.) that are provided to customers (broadly “subscribers”), and to peer networks. In one example, core/backbone network 150 may combine core network components of a cellular network with components of a triple-play service network. For example, communication service provider network 101 may functionally comprise a fixed-mobile convergence (FMC) network, e.g., an IP Multimedia Subsystem (IMS) network. In addition, core/backbone network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Communication service provider network 101 may also further comprise a broadcast video network, e.g., a cable television provider network or an Internet Protocol Television (IPTV) network, as well as an Internet Service Provider (ISP) network. With respect to video/television service provider functions, core/backbone network 150 may include one or more video servers for the delivery of video content, e.g., a broadcast server, a cable head-end, a video-on-demand (VoD) server, and so forth. For example, core/backbone network 150 may comprise a video super hub office, a video hub office and/or a service office/central office.

In one example, access/service networks 110 and 120 may provide one or more services to subscribers and/or customer premises, such as voice, data, video, and/or wireless access services, virtual local area network (VLAN) services, and so forth. For instance, access/service networks 110 and 120 may each comprise a Digital Subscriber Line (DSL) network, a broadband cable access network, a Local Area Network (LAN), a cellular or non-cellular wireless access network, and the like. For example, access/service networks 110 and 120 may transmit and receive communications between endpoint devices 111-113, endpoint devices 121-123, and data center network 130, and between core/backbone network 150 and endpoint devices 111-113 and 121-123 relating to voice telephone calls, communications with web servers via the Internet 160, and so forth. Access/service networks 110 and 120 may also transmit and receive communications between endpoint devices 111-113, 121-123 and other networks and devices via Internet 160. In another example, one or both of the access/service networks 110 and 120 may comprise an ISP network external to communication service provider network 101, such that endpoint devices 111-113 and/or 121-123 may communicate over the Internet 160, without involvement of the communication service provider network 101. Endpoint devices 111-113 and 121-123 may each comprise customer premises equipment (CPE), user equipment (UE), and/or other endpoint device types, such as a telephone, e.g., for analog or digital telephony, a mobile device, such as a cellular smart phone, a laptop, a tablet computer, etc., a router (e.g., a customer edge (CE) router), a gateway, a desktop computer, a plurality or cluster of such devices, a television (TV), e.g., a “smart” TV, or a set-top box (STB).

In one example, the access/service networks 110 and 120 may be different types of access networks. In another example, the access/service networks 110 and 120 may be the same type of access network. In one example, one or more of the access/service networks 110 and 120 may be operated by the same or a different service provider from a service provider operating the communication service provider network 101. For example, each of the access/service networks 110 and 120 may comprise an Internet service provider (ISP) network, a cable access network, and so forth. In another example, each of the access/service networks 110 and 120 may comprise a cellular access network, implementing such technologies as: global system for mobile communication (GSM), e.g., a base station subsystem (BSS), GSM enhanced data rates for global evolution (EDGE) radio access network (GERAN), or a UMTS terrestrial radio access network (UTRAN) network, among others, where core/backbone network 150 may provide cellular core network functions, e.g., of a public land mobile network (PLMN)-universal mobile telecommunications system (UMTS)/General Packet Radio Service (GPRS) core network, or the like. For instance, access/service network(s) 110 may include at least one wireless access point (AP) 119, e.g., a cellular base station, such as an eNodeB, or gNB, a non-cellular wireless access point (AP), such as an Institute of Electrical and Electronics Engineers (IEEE) 802.11 (Wi-Fi) access point, or the like. In still another example, access/service networks 110 and 120 may each comprise a home network or enterprise network, which may include a gateway to receive data associated with different types of media, e.g., television, phone, and Internet, and to separate these communications for the appropriate devices. For example, data communications, e.g., Internet Protocol (IP) based communications may be sent to and received from a router in one of the access/service networks 110 or 120, which receives data from and sends data to the endpoint devices 111-113 and 121-123, respectively.

In this regard, it should be noted that in some examples, endpoint devices 111-113 and 121-123 may connect to access/service networks 110 and 120 via one or more intermediate devices, such as a home or enterprise gateway and/or router, e.g., where access/service networks 110 and 120 comprise cellular access networks, ISPs and the like, while in another example, endpoint devices 111-113 and 121-123 may connect directly to access/service networks 110 and 120, e.g., where access/service networks 110 and 120 may comprise local area networks (LANs), enterprise networks, and/or home networks, and the like.

In one example, communication service provider network 101 may also include one or more network components 155 (e.g., in core/backbone network 150 and/or access/service networks 110 and 120). Network components 155 may include various physical components of communication service provider network 101. For instance, network components 155 may include various types of optical network equipment, such as an optical network terminal (ONT), an optical network unit (ONU), an optical line amplifier (OLA), a fiber distribution panel, a fiber cross connect panel, and so forth. Similarly, network components 155 may include various types of cellular network equipment, such as a mobility management entity (MME), a mobile switching center (MSC), an eNodeB, a gNB, a base station controller (BSC), a baseband unit (BBU), a remote radio head (RRH), an antenna system controller, and so forth. In one example, network components 155 may alternatively or additionally include voice communication components, such as a call server, an echo cancellation system, voicemail equipment, a private branch exchange (PBX), etc., short message service (SMS)/text message infrastructure, such as an SMS gateway, a short message service center (SMSC), or the like, video distribution infrastructure, such as a media server (MS), a video on demand (VoD) server, a content distribution node (CDN), and so forth. Network components 155 may further include various other types of communication network equipment such as a layer 3 router, e.g., a provider edge (PE) router, an integrated services router, etc., an Internet exchange point (IXP) switch, and so on. In one example, network components 155 may further include virtual components, such as a virtual machine (VM), a virtual container, etc., software defined network (SDN) nodes, such as a virtual mobility management entity (vMME), a virtual serving gateway (vSGW), a virtual network address translation (NAT) server, a virtual firewall server, or the like, and so forth. In addition, in one example, network component 155 may include measurement systems, such as network probe devices or the like, to test connectivity across core/backbone network 150, access/service network(s) 110, and/or access/service network(s) 120 (e.g., end-to-end and/or within a selected network segment, etc.). In addition, for ease of illustration, various components of communication service provider network 101 are omitted from FIG. 1.

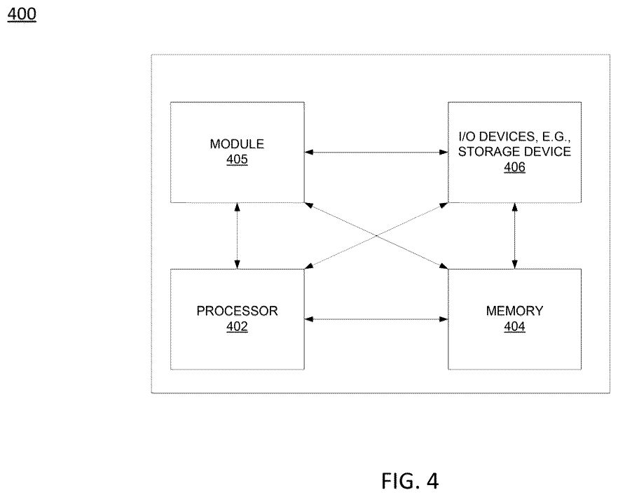

As further illustrated in FIG. 1, communication service provider network 150 may further include one or more server(s) 159. In accordance with the present disclosure, server(s) 159 may comprise one or more instances of a computing system, such as computing system 400 depicted in FIG. 4, and may individually or collectively be configured to perform various, steps, functions, and/or operations in connection with examples of the present disclosure. For instance, server(s) 159 may comprise a service and management orchestrator (SMO) and/or RAN intelligent controller (RAN-IC or RIC), which may obtain alerts, reports, instructions or the like from other network components 155 or components of access networks 110 and/or 120, and may use such information to automatically configure/reconfigure one or more aspects of core/backbone network 150, service network 130, access network(s) 110 and/or access network(s) 120. For instance, server(s) 159, e.g., a SMO, may comprise a self-optimizing network (SON) orchestrator and/or software defined network (SDN) controller. To illustrate, server(s) 159 may function as a self-optimizing network (SON) orchestrator that is responsible for activating and deactivating, allocating and deallocating, and otherwise managing a variety of network components. For instance, server(s) 159 may activate and deactivate antennas/remote radio heads, may allocate and deactivate baseband units (BBUs) in BBU pool, and so forth.

Similarly, server(s) 159 may further comprise a SDN controller that is responsible for instantiating, configuring, managing, and releasing VNFs. For example, in a SDN architecture, a SDN controller may instantiate VNFs on shared hardware, e.g., NFVI/host devices/SDN nodes, which may be physically located in various places. In the present example, some or all of network component(s) 115 may comprise or represent such host devices/NFVI/SDN nodes. In one example, the configuring, releasing, and reconfiguring of SDN nodes may be controlled by the server(s) 159, e.g., a SDN controller, which may store configuration codes, e.g., computer/processor-executable programs, instructions, or the like for various functions which can be loaded onto an SDN node. In another example, the server(s) 159 may instruct, or request an SDN node to retrieve appropriate configuration codes from a network-based repository, e.g., a storage device, to relieve server(s) 159 from having to store and transfer configuration codes for various functions to the SDN nodes. Accordingly, server(s) 159 may be connected directly or indirectly to any one or more network elements of core/backbone network 150, service network 130, access network(s) 110 and/or access network(s) 120, and of the system 100 in general. Due to the relatively large number of connections available between server(s) 159 and other network elements, none of the actual links to the server(s) 159 are shown in FIG. 1.

Still other network components 155 may include a database of assigned telephone numbers, a database of basic customer account information for all or a portion of the customers/subscribers of the communication service provider network 150, a cellular network service home location register (HLR), e.g., with current serving base station information of various subscribers, and so forth, a Simple Network Management Protocol (SNMP) trap, or the like, a billing system, a customer relationship management (CRM) system, a trouble ticket system, an inventory system (IS), an ordering system, an enterprise reporting system (ERS), an account object (AO) database system, and so forth. In addition, other network components 155 may include, for example, a layer 3 router, a database server/database system, and so forth. It should be noted that in one example, a communication network component may be hosted on a single server, while in another example, a communication network component may be hosted on multiple servers, e.g., in a distributed manner.

In accordance with the present disclosure, network components 155 may comprise “network resources” of various network resource types, which may also include services provided and/or hosted via network components 155, e.g., enterprise communication services, such as a virtual private network (VPN) service, a virtual local area network (VLAN) service, a Voice over Internet Protocol (VoIP), a software defined-wide area network (SD-WAN) service, an Ethernet wide area network E-WAN service, and so forth. Alternatively, or in addition, network resources may include interfaces or ports associated with such services, such as a customer edge (CE) router or PBX-to-time division multiplexing (TDM) gateway interface, a Border Gateway Protocol (BGP) interface (e.g., between BGP peers), and so forth. For instance, a CE router, PBX, or the like may be homed to one or several provider edge (PE) routers or other edge component(s).

In one example, the data center network 130 may comprise a local area network (LAN), or a distributed network connected through permanent virtual circuits (PVCs), virtual private networks (VPNs), and the like for providing data and voice communications. In one example, the data center network 130 may comprise one or more devices for providing services to subscribers, customers, and/or users. For example, communication service provider network 101 may provide a cloud storage service, web server hosting, and other services. As such, data center network 130 may represent aspects of communication service provider network 101 where infrastructure for supporting such services may be deployed. In one example, the data center network 130 may alternatively or additionally comprise one or more devices supporting operations and management of communication service provider network 101. For instance, in the example of FIG. 1, server(s) 139 may include higher level services/applications such as a database of assigned telephone numbers, a database of basic customer account information for all or a portion of the customers/subscribers of the communication service provider network 101, a billing system, a customer relationship management (CRM) system, a trouble ticket system, an ordering system, an enterprise reporting system (ERS), an account object (AO) database system, a network inventory system, a network topology/mapping system, a network provisioning system, a unified data repository (UDR), and so forth. In one example, server(s) 139 may alternatively or additionally comprise one or more of the types of network components 155 described above.

In addition, data center network 130 may include one or more servers 135 which may each comprise all or a portion of a computing device or system, such as computing system 400, and/or processing system 402 as described in connection with FIG. 4 below, specifically configured to perform various steps, functions, and/or operations for reconfiguring a communication network according to a network configuration obtained as an output of a generative machine learning model in accordance with a client intent for a network service, as described herein. For example, one of the server(s) 135, or a plurality of the servers 135 collectively, may perform operations in connection with the example method 300, or as otherwise described herein.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

In one example, data center network 130 may also include one or more databases (DBs) 136, e.g., physical storage devices integrated with server(s) 135 (e.g., database servers), attached or coupled to the server(s) 135, and/or in remote communication with server(s) 135 to store various types of information in connection with examples of the present disclosure. For example, DB(s) 136 may be configured to receive and store network topology data, including the type(s) of network resources/network elements (e.g., both physical and virtual), the locations of such network resources, the connectivity between resources, the allocation of such resources to sub-nets, tracking areas, or the like, and so forth. In one example, the network topology information/data may include or may be cross-referenced to network inventory data, such as, for physical network resources, the manufacture date, the purchase date, the deployment date, the last serviced date and/or a service history, identities of the service technician(s), an incident/event list (e.g., for past network events associated with the network resource), a serial number, a model number, a version number, a software version, and so forth. In one example, the network topology data may comprise a network graph, or network graph database. For instance, nodes in the graph/graph database may represent network resources, network zones, etc., where some links/edges may represent physical links, or logical paths over physical links, while other links/edges may represent logical relationships, such as a virtual network function (VNF) being instantiated on a particular network function virtualization infrastructure (NFVI) physical element, a network resource being a component of a particular sub-net or tracking area, etc.

In addition, DB(s) 136 may be configured to receive and store network operational data, including performance indicator data (e.g., “key performance indicators” (KPIs)), such as: utilization and/or availability levels of network resources, configuration settings and/or parameters of such network resources, alarm data, and so forth. For instance, such data may be collected from various network components 155 reporting to server(s) 135 and/or to DB(s) 136, such as routers, RAN elements, cellular core network components, video distribution components, storage servers, content distribution network nodes, etc. In this regard, it should be noted that in one example, network component(s) 115 may also include one or more aggregator devices for collecting performance data (e.g., KPIs) and/or configuration data for various network elements and/or aspects of communication service provider network 101. For instance, such aggregator device(s) may collect performance indicators and/or configuration data over a period of time, and may then provide a batch report and/or aggregated records to DB(s) 136, for instance. It should be noted that some or all of such information (network topology and/or network operational data) may be contained in other network databases/systems, such as one or more of an active and available inventory (A&AI) database, a network inventory database, a call detail records (CDR) repository, or the like (e.g., represented by server(s) 139 and/or various network components 155). Alternatively, or in addition, DB(s) 136 may be configured to receive and store customer/subscriber network resource and/or network service order information (e.g., an additional type or types of network operational data), such as the subscriber/customer identities and other characteristics (e.g., a customer intensity value and/or a customer segment as described herein), the timing of such orders, the quantities of such orders, the type of service(s) ordered, and so forth. In one example, aspects of the abovementioned data may be stored in user, subscriber, and/or account profiles, which may include account owner biographic information, such as individual or entity name, address, phone number(s), device identifier(s), authorized users, age(s), service history, payment history, payment methods, communication preferences, privacy preferences, and so forth. In other words, some of the abovementioned data types may be stored in or linked to respective user/account profiles, or the like. Similar to the above, some or all of such information may be contained in other network databases/systems, such as one or more of an authentication, authorization, and accounting (AAA) server/system, an operations support system (OSS), a business support system (BSS), a unified data repository (UDR), or the like.

It should be noted that in accordance with the present disclosure, the network topology information/data and/or network operational data stored in DB(s) 136 or elsewhere may be maintained over a period of time. For instance, DB(s) 136 may store respective time series data indicative of different states of a network topology, different utilization and/or assignment levels of various network resources of various types in a given time interval (and over a period of a plurality of time intervals), etc. In one example, data may be segregated by customer segment, network zone, geographic region, and so forth.

In one example, DB(s) 136 may alternatively or additionally receive and store data from one or more external data feeds. For instance, DB(s) 136 may receive and store geographic data, e.g., from one or more external services, such as a geographic information system (GIS), which may include digital map data such as geo-political boundary maps, terrain maps, and so forth. Alternatively, or in addition, DB(s) 136 may receive and store weather data from a device of a third-party, e.g., a weather service, a traffic management service, etc. via one of the access/service networks 110 or 120. To illustrate, one of endpoint devices 111-113 or 121-123 may represent a weather data server (WDS). In one example, the weather data may be received via a weather service data feed, e.g., an NWS extensible markup language (XML) data feed, or the like. In another example, the weather data may be obtained by retrieving the weather data from the WDS. In one example, DB(s) 136 may receive and store weather data from multiple third-parties, which can then be correlated to network traffic data to reflect impact of various weather conditions on overall network traffic. Similarly, one of the endpoint devices 111-113 or 121-123 may represent a server of an entertainment event notification service (e.g., a Really Simple Syndication (RSS) feed or the like). In such an example, DB(s) 136 may obtain one or more data sets/data feeds comprising information such as: notifications of mass sporting events, concerts, parades, civic gatherings, etc., including location information, time and duration information, expected attendance, and so forth. For example, such information may be used in connection with network operations in terms of forecasting spikes in demand, network traffic, number of connected devices, etc. in a concentrated area.

In one example, DB(s) 136 may also store artificial intelligence (AI) models and/or machine learning models (MLMs), such as a generative MLM that may be trained by, activated, and/or deployed by server(s) 135 in connection with examples of the present disclosure. In one example, server(s) 135 and/or DB(s) 136 may comprise cloud-based and/or distributed data storage and/or processing systems comprising one or more servers at a same location or at different locations. For instance, DB(s) 136, or DB(s) 136 in conjunction with one or more of the servers 135, may represent a distributed file system, e.g., a Hadoop® Distributed File System (HDFS™), or the like. In one example, the one or more of the servers 135 and/or server(s) 135 in conjunction with DB(s) 136 may comprise a generative MLM-based communication network knowledge platform (e.g., a network-based and/or cloud-based service hosted on the hardware of server(s) 135 and/or DB(s) 136).

It should be noted that as referred to herein, a machine learning model (MLM) (or machine learning-based model) may comprise a machine learning algorithm (MLA) that has been “trained” or configured in accordance with input training data to perform a particular service. For instance, an MLM may comprise a deep learning neural network, or deep neural network (DNN), a convolutional neural network (CNN), a generative adversarial network (GAN), a decision tree algorithm/model, such as gradient boosted decision tree (GBDT) (e.g., XGBoost, XGBR, or the like). In one example, one or more MLMs of the present disclosure may include supervised learning and/or reinforcement learning (e.g., using positive and negative examples after deployment as a MLM), and so forth. In one example, MLAs/MLMs of the present disclosure may be in accordance with an open source library, such as OpenCV, which may be further enhanced with domain-specific training data. In one example, MLMs of the present disclosure may include an ML-based generative model, such as a language model, e.g., a “large language model” (LLM). For instance, an ML-based generative model used in the present examples may comprise a generative adversarial network (GAN), a bidirectional encoder representations from transformers (BERT) model (e.g., BERT-Base, BERT-Large, etc.), a generative pre-training (GPT) model (e.g. GPT, GPT-2, GPT-3, or the like), a semantic graphs-based pre-training (SGPT) model, or other generative natural language processing (NLP) models. In one example, MLMs of the present disclosure may comprise an ada text embedding model.

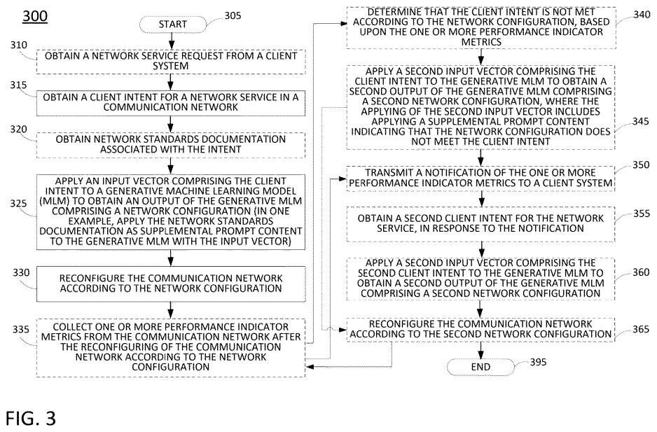

As noted above, server(s) 135 may be configured to perform various steps, functions, and/or operations for reconfiguring a communication network according to a network configuration obtained as an output of a generative machine learning model in accordance with a client intent for a network service, as described herein. For instance, an example method for reconfiguring a communication network according to a network configuration obtained as an output of a generative machine learning model in accordance with a client intent for a network service is illustrated in FIG. 3 and described in greater detail below. To further illustrate, server(s) 135 may obtain a client intent for a network service from a client system (e.g., one of the endpoint devices 111-113 or 121-123). For instance, in one example, server(s) 135 may obtain a network service request, e.g., in a natural language format, from a client system. Server(s) 135 may then map the network service request to the client intent, e.g., via an intent matching function. In one example, the client intent may be of a defined intent type having a template (e.g., from among a plurality of client intent types with respective templates). For example, the client intent, or template associated with the client intent may define one or more performance indicator thresholds for one or more network performance indicators types, such as: one or more physical interface performance indicator types, one or more logical interface performance indicator types, one or more computing equipment performance indicator types, one or more environmental performance indicator types, one or more end-to-end data flow performance indicator types, or the like.

In one example, server(s) 135 may next obtain network standards documentation associated with the intent, such as 3GPP technical standards documentation, Internet Engineering Task Force (IETF) standards documents (e.g., RFCs that have status of Internet Standard or Best Current Practice (BCP), or the like), International Telecommunication Union Telecommunication Standardization Sector (ITU-T) recommendations, standards and/or specifications, e.g., Data Over Cable Service Interface Specification (DOCSIS), etc., IEEE standards (e.g., 802.11/Wi-Fi standards, etc., or the like. For instance, in one example, such documentation may have previously been retrieved, e.g., from the Internet 160, and stored in the DB(s) 136. Server(s) 135 may then apply an input vector comprising the client intent to a generative MLM to obtain an output of the generative MLM comprising a network configuration. For instance, as indicated above, in one example the generative MLM may comprise a large language model (LLM), such as generative pre-trained transformer (GPT) model or the like. In one example, the client intent or the template associated therewith may include a prompt template comprising a format for inputting a prompt, also referred to herein as an input vector, to the generative MLM. In one example, the retrieved network standards documentation may be applied as supplemental prompt content to the generative MLM along with the input vector. In one example, the generative MLM may be implemented by the server(s) 135. Thus, server(s) 135 may process the input vector and supplemental prompt content in accordance with the generative MLM (e.g., instructions, code, variables, etc. which may cause server(s) 135 to perform the functions of the generative MLM). In one example, the generative MLM may be trained/configured to generate recommended network configurations in response to prompts/input vectors associated with client intents in accordance with the present disclosure.

Accordingly, server(s) 135 may thus obtain an output of the generative MLM comprising a recommended network configuration in response to the client intent (and the request for a network service). To further illustrate, the network configuration may include one or more network functions to support the network service, one or more configuration settings of the one or more network functions to support the network service, the desired links/interfaces and bandwidth for the links/interfaces, etc. Lastly, server(s) 135 may reconfigure one or more aspects of the communication service provider network 101 according to the network configuration. For example, the reconfiguring may include instantiating one or more network functions via network function virtualization infrastructure (NFVI) to support the network service, transmitting at least one instruction to at least one network function (NF) (e.g., one or more of network component(s) 155) to adjust at least one configuration setting to support the network service, or allocating bandwidth on at least one interface to support the network service. In one example, server(s) 135 may refer to information in DB(s) 136 to assist in completing the reconfiguring (e.g., accessing network inventory and network topology information to determine whether NFs exist that may support the network configuration, whether NFVI/SDN nodes is/are available where VNFs can be instantiated to support the network configuration, whether NVFI, NFs, etc. are in data centers with links that are short and/or fast enough to meet latency factors of the network configuration, whether a network slice load level is such that additional traffic for the new network service can be accommodated within the particular slice, whether edge computing resources may be available to host an edge server in support of the network configuration, and so forth). It should be noted that in another example, it may be determined that an existing network configuration may already meet the client intent for the network service. In one example, the reconfiguring may include transmitting an instruction to a service management orchestrator (SMO), e.g., server(s) 159, to implement the reconfiguring according to the network configuration.

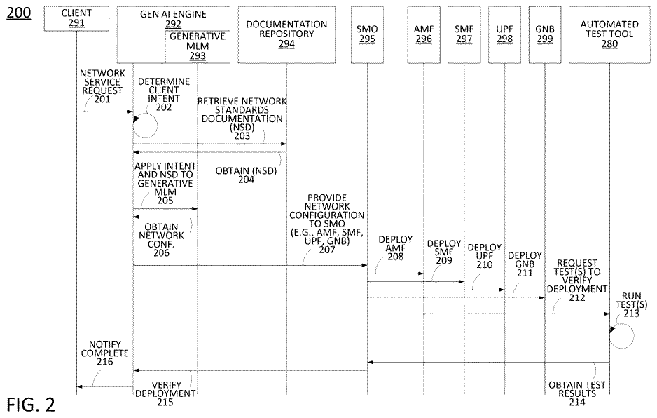

Additional operations of server(s) 135 may include collecting one or more network performance indicator metrics (e.g., KPI measurements) after the reconfiguring. In addition, server(s) 135 may determine that the client intent is not met according to the network configuration, based upon the one or more network performance indicator metrics. In such case, server(s) 135 may apply a second input vector comprising the client intent to the generative MLM to obtain a second output of the generative MLM comprising a second network configuration, where this step may include applying a supplemental prompt content indicating that the network configuration did not meet the client intent. Alternatively, or in addition, server(s) 135 may transmit a notification of the one or more performance indicator metrics to a client system (e.g., one or more of endpoint devices 111-113 or 121-123). Server(s) 135 may further obtain a second client intent for the network service, in response to the notification, apply a second input vector comprising the second client intent to the generative MLM to obtain a second output of the generative MLM comprising a second network configuration, and reconfigure one or more aspects of the communication service provider network 101 according to the second network configuration. Servers(s) 135 may alternatively or additionally perform various operations as described in connection with FIG. 2 and/or FIG. 3, or elsewhere herein.

In addition, it should be realized that the system 100 may be implemented in a different form than that illustrated in FIG. 1, or may be expanded by including additional endpoint devices, access networks, network elements, application servers, etc. without altering the scope of the present disclosure. As just one example, any one or more of the server(s) 135 and DB(s) 136 may be distributed at different locations, such as in or connected to access/service networks 110 and 120, in another service network connected to Internet 160 (e.g., a cloud computing provider network), in core/backbone network 150, and so forth. Thus, these and other modifications are all contemplated within the scope of the present disclosure.

FIG. 2 illustrates an example process 200 for providing an automatic generative MLM-based network service configuration, in accordance with the present disclosure. In particular, the process 200 may be implemented by a generative MLM-based network system, such as server(s) 135 and/or server(s) 159 of FIG. 1, or the like. For example, the generative AI engine 292 may be the same as or similar to server(s) 135 of FIG. 1, and the SMO 295 may be the same as or similar to server(s) 159 of FIG. 1.

As illustrated in FIG. 2, the process 200 may begin at 201 with generative AI engine 292 obtaining a network service request 201, e.g., in a natural language (NL) format, from client 291. For instance, an example request may be: “I'd like a new virtual private network for our enterprise locations in New York and California,” “I'd like support massive multiplayer online gaming using my new VR headset,” or the like. It should be noted that network service request of 201 may also be considered or referred to as a “prompt.” However, to disambiguate from other aspects of the present disclosure, the term “request” may primarily be used to refer to a user's NL input requesting a network service.

At 202, the generative AI engine 292 may determine a client intent based on the network service request. For example, the present disclosure may include a plurality of available client intent types, that is, network services that may be requested and provided via the communication network. For instance, each of the client intent types may comprise or may have an associated template. In addition, each of the templates may be defined or characterized by one or more network performance indicator thresholds, as discussed above. In one example, one or more of the templates may further include one or more constraints, such as a restriction associated with where one or more network functions may be placed within the communication network (e.g., geographic and/or network zone), a restriction associated with where data traffic for the network service may be routed in transit, a sharing condition relating to one or more network functions or links (e.g., no sharing with other user traffic on a link, no use of NF for other user traffic, and/or no sharing of hardware with NFs for others), and so forth. In one example, such a template may have a format that is usable as a prompt/input vector for a generative MLM. For instance, the template may include fixed content and variable content, such as: “Provide a network configuration for a virtual reality/extended reality application service where: the end-to-end latency is no more than 3 ms, downlink throughput is no less than 50 MB/s, and uplink throughput is no less than 15 MB/s. There should be at least one edge server dedicated to viewport rendering that is as close to the client as possible. The client is located at “ABC location.” The client device is an “XYZ device.” In another example, such a template may be: “Provide a network configuration for a virtual reality/extended reality application service to a plurality of users at different locations where: the end-to-end latency is no more than 3 ms, downlink throughput is no less than 50 MB/s, and uplink throughput is no less than 15 MB/s.” There should be at least one edge server dedicated to viewport rendering that is as close to the clients as possible. The clients are located at “ABC location and BCD location.” The client devices include “WXY device and XYZ device.” For instance, in the first example, the template and the client intent may assume that a network service is for a single AR/VR device, while in the second example, the template and the client intent may assume a multi-user AR/VR service. In one example, these may comprise two available templates for two different client intent types, e.g., AR/VR—single user, and AR/VR—multi user, or the like.

In one example, the intent mapping function may comprise a natural language processing (NLP) function, e.g., a machine learning model (MLM). In particular, such an MLM may comprise a NLP classifier that takes a natural language input and that generates an output comprising a client intent type as an output. For example, the NLP function may comprise a support vector machine (SVM) or multiple SVMs (e.g., one per client intent type), a K-nearest neighbors (KNN) model, a random forest, a CNN, a RNN, an LSTM model, and so forth. In one example, the input natural language content may be vectorized, e.g., via word2vec, doc2vec, Global Vectors for Word Embedding (GloVe), or the like, using n-grams, and so forth.

In one example, client intents may be predefined. However, in one example, new client intents may be generated, e.g., by a system operator or a user. For instance, new client intents may be defined by different sets/combinations of network performance indicator thresholds and/or other requirements/constraints. In one example, new client intents may be learned over time, e.g., from instances were a client has indicated that a network deployment/configuration is not satisfactory, even though it may comply with the performance indicator thresholds and/or other constraints of the initially determined client intent. For instance, a client may request a “low latency” network service, but the service may perform poorly because the client actually intended for the network service to support 1000 or more endpoint devices, which was not originally specified. In this case, the client may provide feedback that the network service should have greater throughput per endpoint device when supporting 1000 or more endpoint devices. In this case, the client may be asked if the client would like to create a new client intent. In one example, the client may choose to create such a new client intent, and may label the client intent “low latency—large enterprise,” or the like. Alternatively, or in addition, new client intents may be defined manually, e.g., on-demand and at any time at the discretion of a system operator and/or a client that may be authorized to generate new client intents. In one example, the NLP model, or models may be updated to accommodate additional classifications/categories, e.g., for the new client intent(s) that may be added.

In 203, the generative AI engine 292 may retrieve network standards documentation from a documentation repository 294 (such as DB(s) 136 in FIG. 1, or the like). In one example, the network standards documentation may be 3GPP technical standards and/or others such as mentioned above. In one example, the network standards documentation may be specific to the client intent determined at 202. For instance, the generative AI engine 292 may obtain the top “N” number of documents that may be relevant to the client intent. For instance, the client intent may comprise an input to a search engine that will return matching documents to respective client intents that may be input. For example, the search engine may use a term frequency-inverse document frequency term search matching terms that exist in the client intent to terms that are contained in respective documents in the document repository. In one example, the search may be further based upon additional context, such as the identity or type of client. For instance, a cellular client may be mapped to a search that may be bounded within 3GPP documentation, while a cable access network client may be mapped to a search that may be bound within DOCSIS documentation, and so forth. Furthermore, addition client information may be used as supplemental input(s) to the search criteria. For example, client records may indicate that the client is a fixed wireless broadband client. As such, this may be provided as part of the search terms. For instance, there may be certain technical standards documents that are more relevant to fixed wireless broadband (FWB) than for general mobile endpoint device use cases.

In any case, the generative AI engine 292 may obtain the network standards documentation at 204 and at 205 may apply the client intent and the network standards documentation to the generative MLM 293. For example, the client intent may comprise an input vector/prompt for the generative MLM 293. In addition, the network standards documentation may be applied as supplemental prompt content. For instance, 203-205 may embody a retrieval augmented generation (RAG) process when applying the intent to the generative MLM 293. For instance, domain knowledge may be embedded in the prompt (e.g., the input vector comprising or associated with the client intent) or provided along with the prompt). For instance, this may comprise vectorized information from the network standards documentation. Notably, this supplemental prompt input data may bias the generative MLM 293 to be more likely to generate an appropriate network configuration, e.g., which is more likely to result in the meeting the client intent (e.g., satisfying the one or more performance indicator thresholds of the client intent).

In one example, client information may be further provided as supplemental prompt content. For instance, it may be learned over time that a client may object to all network deployments/network configurations that involve NFs that reside on anon-domestic (e.g., non-United States) physical infrastructure, e.g., due to specific contract requirements and/or confidentiality concerns. Accordingly, even if the client does not specify this in the request at 201, and even if the particular constraint of “domestic infrastructure required” is not part of the client intent/template, this “learned user preference” may still be included as supplemental prompt content, which may further predispose the generative MLM to be more likely to generate a recommended network configuration that avoids non-domestic infrastructure.

The generative MLM 293 may comprise, for example, a large language model (LLM). For instance, the generative MLM 293 may comprise a generative pre-trained transformer (GPT) model, a Large Language Model Meta AI (LLaMA) model, a Language Model for Dialogue Applications (LaMDA) model, a Pathways Language Model (PaLM) model, a bidirectional transformer that is pre-trained for language understanding/natural language processing (NLP) tasks (e.g., a Bidirectional Encoder Representations from Transformers (BERT) model), and so forth. In one example, the generative MLM 293 may include a mixture of experts or ensemble of multiple base MLMs.

In one example, different MLMs may be possessed by the generative AI engine 292, where based on the accuracy/quality of the response/output, these MLMs can be reconfigured/retrained in an adaptive way. As such, in one example, the generative MLM 293 may comprise one or more MLMs that are selected via an auto-ML process. For instance, an operator may provide one or more optimization criteria to obtain the best performing model(s) with respect to accuracy, speed, a combination of such factors, etc. In addition, in one example, the generative MLM 293 may be adapted from a pre-trained model, where the framework of the generative MLM-based communication network knowledge platform may be used to modify and retune the adopted model(s), e.g., specifically to generate recommended network configurations, and in one example, more specifically with respect to a particular network operator's communication network. Thus, it should be noted that training of the generative MLM 293 can be accomplished in different ways such as training from scratch, fine-tuning of a pre-trained model, retrieval-augmented generation (RAG), reinforcement learning using feedback, prompting/prompt-tuning, learning using adapters, a combination of any of the foregoing, and so forth.

At 206, the generative AI engine 292 may obtain a network configuration as the output of the generative MLM 293 in response to the intent and network standards documentation as input vector/prompt and supplemental prompt content, respectively. The network configuration may include one or more network functions to support the network service, one or more configuration settings of the one or more network functions to support the network service, the desired links/interfaces and bandwidth for the links/interfaces, etc. In the present example, the request (and the client intent) may be for a low latency network service. In this case, the recommended network configuration may include the four network elements, or network functions (NFs): AMF, SMF, UPF, and gNB. At 207, the generative AI engine 292 may provide the network configuration to SMO 295, e.g., with a request/instruction(s) to implement the network configuration. SMO 295 may then deploy the respective NFs at 208-211, respectively. For instance, the deploying may include instantiating the respective NFs, e.g., as VNFs on shared hardware/NFVI, reallocating NFs to the network service for the client 291, reserving processor, memory, bandwidth, and/or other resources of the NFs to accommodate network traffic for the client 291, and so forth. It should also be noted that although 208-211 are illustrated sequentially, it should be understood that in other, further, and different examples, the respective NFs may be deployed in a different order, in parallel, etc.

At 212, the SMO 295 may request that an automated test tool 280 perform one or more network tests or measurements to verify that the deployment meets the client intent. For example, the automated test tool 280 may comprise a monitoring agent that may inject synthetic traffic into the communication network and which may measure the various network performance indicators, such as packet loss, throughput, jitter, a call failure rate, a call drop rate, received signal strength, and so forth. In one example, the automated test tool 280 may further include an application simulator or one or more devices in the communication network that may simulate one or more network conditions, e.g., during which network performance indicators may be measured to verify compliance with a client intent. Alternatively, or in addition, the automated test tool 280 may comprise a Simple Network Management Protocol (SNMP) manager, or server, which may be in communication with various NFs, and which may collect network performance indicator data from the NFs, e.g., under one or more different network conditions, which may be naturally occurring or which may be synthetically generated, e.g., by the automated test tool 280 itself.

At 214 the SMO 295 may obtain the results of the test(s) run by the automated test tool 280. For instance, these may comprise one or more network performance indicator values for one or more network performance indicator types associated with the client intent. At 215, the SMO 295 may verify the deployment/network configuration meets the client intent. For example, 215 may include comparing the one or more network performance indicator values to one or more performance indicator thresholds associated with/defined by the client intent. When the measured network performance indicator values meet or exceed the respective threshold(s), SMO 295 may determine that the deployment of the network configuration satisfies the client intent. At 215, the SMO 295 may verify the deployment to the generative AI engine 292. For instance, SMO 295 may transmit a message/notification indicating that the deployment is ready to accommodate the network service and to meet the constraints of the client request and/or the client intent. At 216, the generative AI engine 292 may transmit a confirmation to the client 291 that a network deployment to support/provide the network service is complete. Thus, the client 291 may be made aware that it can begin sending and/or receiving data traffic over the communication network in accordance with the network service.

In addition, it should be realized that the process 200 may be implemented in a different form than that illustrated in FIG. 2, or may be expanded or modified by including additional or different stages/operations, omitting stages/operations, etc. For example, NFs may be deployed in a different order that 208-211 and/or some deployments/instantiations may be performed in parallel. Similarly, while the example of FIG. 2 illustrates a process 200 in connection with a “low latency” client intent, other requests, and other client intents may involve deployment of different NFs, different settings for such NFs, and so forth. Thus, these and other modifications are all contemplated within the scope of the present disclosure.

FIG. 3 illustrates a flowchart of an example method 300 for reconfiguring a communication network according to a network configuration obtained as an output of a generative machine learning model in accordance with a client intent for a network service. In one example, steps, functions, and/or operations of the method 300 may be performed by a device as illustrated in FIG. 1, e.g., one or more of the servers 135, or the like. Alternatively, or in addition, the steps, functions and/or operations of the method 300 may be performed by a processing system collectively comprising a plurality of devices as illustrated in FIG. 1 such as one or more of the server(s) 135 in conjunction with one another and/or one or more of server(s) 159, DB(s) 136, network component(s) 155, endpoint devices 111-113 and/or 121-123 (e.g., user equipment (UE), or the like), and so forth. In one example, the steps, functions, or operations of method 300 may be performed by a computing device or system 400, and/or a processing system 402 as described in connection with FIG. 4 below. For instance, the computing device 400 may represent at least a portion of a platform, a server, a system, and so forth, in accordance with the present disclosure. For illustrative purposes, the method 300 is described in greater detail below in connection with an example performed by a processing system. The method 300 begins in step 305 and may proceed to optional step 310 or to step 315.

At optional step 310, the processing system may obtain a network service request, e.g., in a natural language format, from the client system. For instance, the network service request may be for a network service in a communication network. Example network service requests may include “I'd like a new virtual private network for our enterprise locations in New York and California,” “I'd like support massive multiplayer online gaming using my new VR headset,” or the like.

At step 315, the processing system may obtain a client intent for a network service in a communication network. For instance, in one example, the processing system may obtain a network service request, e.g., in a natural language format, from the client system at optional step 310. The processing system may then map the network service request to the client intent, e.g., via an intent matching function at step 315. For instance, as discussed above, the client intent may be of a defined intent type having a template (e.g., from among a plurality of client intent types with respective templates). For example, the client intent, or template associated with the client intent may define one or more performance indicator thresholds for one or more network performance indicators types, such as: one or more physical interface performance indicator types, one or more logical interface performance indicator types, one or more computing equipment performance indicator types, one or more environmental performance indicator types, one or more end-to-end data flow performance indicator types, or the like. In one example, the template may further define one or more constraints, such as a restriction associated with where one or more network functions may be placed within the communication network (e.g., geographic and/or network zone), a restriction associated with where data traffic for the network service may be routed in transit, a sharing condition relating to one or more network functions or links (e.g., no sharing with other user traffic on a link, no use of NF for other user traffic, and/or no sharing of hardware with NFs for others), and so forth.

As discussed above, in one example, the intent mapping function may comprise a natural language processing (NLP) function, e.g., a machine learning model (MLM). In particular, such an MLM may comprise a NLP classifier that takes a natural language input and that generates an output comprising a client intent type as an output. For example, the NLP function may comprise a SVM or multiple SVMs (e.g., one per client intent type), a KNN model, a random forest model, a CNN, a RNN, a LSTM model, and so forth. In one example, the input natural language content from optional step 410 may be vectorized, e.g., via word2vec, doc2vec, GloVe, or the like, using n-grams, and so forth. In one example, if the intent mapping is not conclusive, e.g., the confidence of classification of a client request to a client intent does not exceed a predefined threshold, e.g., 75% confidence/accuracy, 80 percent accuracy, etc., step 315 may include an interactive message exchange with the client system, such as presenting a request for clarification, e.g., “Sorry, I didn't get that. Please try rephrasing your request” or the like. Similarly, the processing system may present suggested requests or request formats, such as “you can say ‘please provide a network service for low latency cellular data’ or ‘please provide a network service for smart city support in neighborhood XYZ,’” etc. Accordingly, the client system may provide one or more revised requests, which may be similarly processed via the intent mapping function.

At optional step 320, the processing system may obtain network standards documentation associated with the intent, such as 3GPP technical standards documentation, IETF standards documents, ITU-T recommendations, standards and/or specifications, IEEE standards, or the like. For instance, in one example, such documentation may have previously been retrieved and stored in a local database accessible to the processing system, e.g., within the communication network infrastructure itself. In one example, the network standards documentation may be pre-vectorized, e.g., via word2vec, doc2vec, GloVe, or the like, for use in subsequent steps.

In one example, the network standards documentation may be specific to the client intent determined at 315. For instance, the processing system may obtain the top “N” number of documents that may be relevant to the client intent. For instance, the client intent may comprise an input to a search engine implemented by the processing system that matches documents to respective client intents that may be input. For example, the search engine may use a term frequency-inverse document frequency term search for matching terms that exist in the client intent to terms that are contained in respective documents in the document repository (or similar search algorithm). In one example, the search may be further based upon additional context, such as the identity or type of client.

At step 325, the processing system may apply an input vector comprising the client intent to a generative MLM to obtain an output of the generative MLM comprising a network configuration. For instance, as indicated above, in one example the generative MLM may comprise a LLM, such as a Generative Pre-Trained Transformer (GPT) model or the like. In one example, the client intent or the template associated therewith may include a prompt template comprising a format for inputting a prompt, also referred to herein as an input vector, to the generative MLM. In one example, the retrieved network standards documentation may be applied as supplemental prompt content to the generative MLM along with the input vector. In one example, the generative MLM may be implemented by the processing system. Thus, the processing system may execute the functions of the generative MLM (e.g., instructions, code, variables, etc. which may cause the processing system to perform the functions of the generative MLM) in accordance with the input vector and supplemental prompt content. Accordingly, the processing system may obtain an output of the generative MLM comprising a network configuration in response to the client intent (and the request for a network service). To further illustrate, the network configuration may include one or more network functions to support the network service, one or more configuration settings of the one or more network functions to support the network service, the desired links/interfaces and bandwidth for the links/interfaces, etc.

At step 330, the processing system reconfigures the communication network according to the network configuration. For example, the reconfiguring may include instantiating one or more network functions via NFVI (e.g., host devices, SDN nodes, or the like) to support the network service, transmitting at least one instruction to at least one NF to adjust at least one configuration setting to support the network service, or allocating bandwidth on at least one interface to support the network service. In one example, the reconfiguring may include transmitting an instruction to a service management orchestrator (SMO) to implement the reconfiguring according to the network configuration. It should again be noted that the network configuration may include the NFs to support the network service, some of which may exist and some of which may be instantiated at step 330. Step 330 may also include instructions to NFs to implement particular configuration settings to support the network service, to establish or update the desired links/interfaces and bandwidth for the links/interfaces, and so forth. Following step 330, the method 300 may proceed to step 395 where the method 300 may end, or may proceed to optional step 335.

At optional step 335, the processing system may collect one or more performance indicator metrics from the communication network after the reconfiguring of the communication network according to the network configuration. For instance, the processing system may comprise or may instruct a monitoring agent that may inject synthetic traffic into the communication network and which may the measure various network performance indicators, such as packet loss, throughput, jitter, a call failure rate, a call drop rate, received signal strength, and so forth. In one example, the processing system may comprise or may instruct an application simulator, or one or more devices in the communication network may simulate one or more network conditions, e.g., during which network performance indicators may be measured. Alternatively, or in addition, the processing system may comprise or may instruct a SNMP manager, or server, which may be in communication with various NFs, and which may collect network performance indicator data from the NFs, e.g., under one or more different network conditions, which may be naturally occurring or which may be synthetically generated. Following optional step 335, the method 300 may proceed to optional step 340 or to optional step 350.

At optional step 340, the processing system may determine that the client intent is not met according to the network configuration, based upon the one or more performance indicator metrics (e.g., where the client intent is defined by one or more performance indicator thresholds for the communication network as described above).

At optional step 345, the processing system may apply a second input vector comprising the client intent to the generative MLM to obtain a second output of the generative MLM comprising a second network configuration, where the applying of the second input vector may include applying a supplemental prompt content indicating that the network configuration does not meet the client intent. For instance, optional step 345 may be performed in response to the determining at optional step 340 that the client intent is not met according to the network configuration, based upon the one or more network performance indicator metrics. Following optional step 345, the method 300 may proceed to optional step 365.

As noted above, following optional step 335, the method 300 may proceed to optional step 340 or to optional step 350. At optional step 350, the processing system may transmit a notification of the one or more performance indicator metrics to the client system. At optional step 355, the processing system may further obtain a second client intent for the network service, in response to the notification. For instance, the notification may include a suggestion to the client system that it is possible to revise the request. In one example, optional step 355 may include obtaining a second natural language request and mapping the second request to the second client intent, retrieving network standards documentation, and applying the network standards documentation as supplemental prompt content. At optional step 360, the processing system may apply a second input vector comprising the second client intent to the generative MLM to obtain a second output of the generative MLM comprising a second network configuration. Following step 360, the method 300 may proceed to optional step 365. Similarly, following optional step 345, the method 300 may proceed to optional step 365.

At optional step 365, the processing system may reconfigure one or more aspects of the communication network according to the second network configuration. For instance, optional step 365 may comprise the same or similar operations as step 330, but with a different network configuration (e.g., a different set of one or more NFs, NF configuration settings, etc.). Following optional step 365, the method 300 may return to step 335, e.g., to continue to verify the second network configuration/network deployment, etc., or may proceed to step 395 where the method 300 ends.

It should be noted that method 300 may be expanded to include additional steps, or may be modified to replace steps with different steps, to combine steps, to omit steps, to perform steps in a different order, and so forth. For instance, in one example, the processing system may repeat one or more steps of the method 300, such as steps 310-330, steps 310-335, steps 310-340, etc. for new network service request(s), steps 335-365 to reconfigure the communication network with subsequent network configuration updates (e.g., in response to client requests and/or in an automated manner following a determination that a client intent is not met with a current network configuration/network deployment), and so forth. In one example, the method 300 may include providing suggested requests/prompts prior to obtaining the NL request at step 310. In one example, optional step 320 may alternatively comprise submitting a search request to a search engine that is external to the processing system, e.g., which may be associated with the documentation repository. In one example, the method 300 may include storing NL requests, the prompts/input vectors used, the network configurations generated therefrom, etc. e.g., for ongoing learning and model retraining, etc. For instance, in one example, the method 300 may include obtaining feedback and retraining the intent mapping function and/or the generative model(s). Alternatively, or in addition, the method 300 may include other pre- or post-processing operations, such as ETL operations, data cleansing, sanitizing, averaging, etc. In one example, the method 300 may include initial training of the generative model, the intent mapping function (e.g., another MLM), etc. In one example, the method 300 may be expanded or modified to include steps, functions, and/or operations, or other features described above in connection with the example(s) of FIG. 1 and/or FIG. 2, or as described elsewhere herein. Thus, these and other modifications are all contemplated within the scope of the present disclosure.

In addition, although not specifically specified, one or more steps, functions, or operations of the method 300 may include a storing, displaying, and/or outputting step as required for a particular application. In other words, any data, records, fields, and/or intermediate results discussed in the method 300 can be stored, displayed and/or outputted either on the device executing the method 300, or to another device, as required for a particular application. Furthermore, steps, blocks, functions, or operations in FIG. 3 that recite a determining operation or involve a decision do not necessarily require that both branches of the determining operation be practiced. In other words, one of the branches of the determining operation can be deemed as an optional step. In addition, one or more steps, blocks, functions, or operations of the above described method 300 may comprise optional steps, or can be combined, separated, and/or performed in a different order from that described above, without departing from the examples of the present disclosure.

FIG. 4 depicts a high-level block diagram of a computing device or processing system specifically programmed to perform the functions described herein. For example, any one or more components or devices illustrated in FIGS. 1 and 2, or described in connection with the examples of FIG. 3 may be implemented as the processing system 400. As depicted in FIG. 4, the processing system 400 comprises one or more hardware processor elements 402 (e.g., a microprocessor, a central processing unit (CPU) and the like), a memory 404, (e.g., random access memory (RAM), read only memory (ROM), a disk drive, an optical drive, a magnetic drive, and/or a Universal Serial Bus (USB) drive), a module 405 for reconfiguring a communication network according to a network configuration obtained as an output of a generative machine learning model in accordance with a client intent for a network service, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in FIG. 4, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of FIG. 4 is intended to represent each of those multiple computing devices. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for reconfiguring a communication network according to a network configuration obtained as an output of a generative machine learning model in accordance with a client intent for a network service (e.g., a software program comprising computer-executable instructions) can be loaded into memory 404 and executed by hardware processor element 402 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for reconfiguring a communication network according to a network configuration obtained as an output of a generative machine learning model in accordance with a client intent for a network service (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
obtaining, by a processing system including at least one processor, a client intent for a network service in a communication network;
applying, by the processing system, an input vector comprising the client intent to a generative machine learning model to obtain an output of the generative machine learning model comprising a network configuration; and
reconfiguring, by the processing system, the communication network according to the network configuration.

2. The method of claim 1, further comprising:
obtaining a network service request from a client system.

3. The method of claim 2, wherein the obtaining of the client intent for the network service comprises mapping the network service request to the client intent.

4. The method of claim 3, wherein the mapping is via an intent mapping function.

5. The method of claim 3, wherein the client intent is of a defined intent type having a template.

6. The method of claim 5, wherein the template defines one or more performance indicator thresholds for one or more network performance indicator types.

7. The method of claim 6, wherein the template further defines one or more constraints, wherein the one or more constraints relate to one or more of:
a restriction associated with where one or more network functions may be placed within the communication network;
a restriction associated with where data traffic for the network service may be routed in transit; or
a sharing condition relating to one or more network functions or links.

8. The method of claim 1, wherein the client intent is defined by one or more performance indicator thresholds for one or more network performance indicator types, wherein the one or more network performance indicator types include at least one of:
at least one physical interface performance indicator type;
at least one logical interface performance indicator type;
at least one computing equipment performance indicator type;
at least one environmental performance indicator type; or
at least one end-to-end data flow performance indicator type.

9. The method of claim 1, further comprising:
collecting one or more performance indicator metrics from the communication network after the reconfiguring of the communication network according to the network configuration.

10. The method of claim 9, further comprising:
determining that the client intent is not met according to the network configuration, based upon the one or more performance indicator metrics, wherein the client intent is defined by one or more performance indicator thresholds for the communication network.

11. The method of claim 10, further comprising:
applying a second input vector comprising the client intent to the generative machine learning model to obtain a second output of the generative machine learning model comprising a second network configuration, wherein the applying of the second input vector includes applying a supplemental prompt content indicating that the network configuration does not meet the client intent.

12. The method of claim 9, further comprising:
transmitting a notification of the one or more performance indicator metrics to a client system;
obtaining a second client intent for the network service, in response to the notification;
applying a second input vector comprising the second client intent to the generative machine learning model to obtain a second output of the generative machine learning model comprising a second network configuration; and
reconfiguring the communication network according to the second network configuration.

13. The method of claim 1, wherein the network configuration comprises at least one of:
one or more network functions to support the network service; or
one or more configuration settings of the one or more network functions to support the network service.

14. The method of claim 1, further comprising:
obtaining network standards documentation associated with the client intent, wherein the network standards documentation is applied as supplemental prompt content to the generative machine learning model along with the input vector.

15. The method of claim 1, wherein the reconfiguring comprises:
instantiating one or more network functions via network function virtualization infrastructure to support the network service;
transmitting at least one instruction to at least one network function to adjust at least one configuration setting to support the network service; or
allocating a bandwidth on at least one interface in the communication network to support the network service.

16. The method of claim 1, wherein the reconfiguring comprises:
transmitting an instruction to a service management orchestrator of the communication network to implement the reconfiguring according to the network configuration.

17. The method of claim 1, wherein the generative machine learning model comprises a large language model.

18. The method of claim 1, wherein the generative machine learning model comprise a generative pre-trained transformer model.

19. A non-transitory computer-readable medium storing instructions which, when executed by a processing system including at least one processor, cause the processing system to perform operations, the operations comprising:
obtaining a client intent for a network service in a communication network;
applying an input vector comprising the client intent to a generative machine learning model to obtain an output of the generative machine learning model comprising a network configuration; and
reconfiguring the communication network according to the network configuration.

20. An apparatus comprising:
a processing system including at least one processor; and
a computer-readable medium storing instructions which, when executed by the processing system, cause the processing system to perform operations, the operations comprising:
obtaining a client intent for a network service in a communication network;
applying an input vector comprising the client intent to a generative machine learning model to obtain an output of the generative machine learning model comprising a network configuration; and
reconfiguring the communication network according to the network configuration.
